(19) United States
(12) Patent Application Publication
(10) Pub. No.: US 2024/0144734 A1
(43) Pub. Date: May 2, 2024

(54) Method of using a handheldable pulling and compressing device for repair of motor vehicle components

(71) Applicant: TKR Spezialwerkzeuge GmbH, Gevelsberg (DE)

(72) Inventors: Torsten Kreischer, Wetter (DE); Thorsten Weyland, Herdecke (DE)

(21) Appl. No.: 18/494,851

(22) Filed: Oct. 26, 2023

(30) Foreign Application Priority Data
Oct. 28, 2022 (DE) 10 2022 128 654.1

(51) Int. Cl. G07C 5/00; G06V 20/64

(52) U.S. Cl. CPC G07C 5/006; G06V 20/64; G07C 5/008

(57) ABSTRACT

The invention relates to a method for using a handheldable pulling and compressing device for the repair of motor vehicle components and a system for carrying out the method. In order to provide a method for the use of a handheld pulling and compressing device for the repair of motor vehicle components as well as a system for carrying out the method, which enables a quick and reliable selection of a suitable tool in a simple manner, it is provided that a motor vehicle component to be machined is identified by means of a mobile handheld device comprising a display unit and a transmitting and receiving unit for wireless data transmission of information to a server unit. A tool suitable for machining the identified motor vehicle component is selected by means of the mobile handheld device or the server unit, and information about the suitable tool is displayed on the display unit of the mobile handheld device. Thereupon, the suitable tool is arranged on a tool holder of the handheldable pulling and compressing device, and the motor vehicle component is machined by means of the handheldable pulling and compressing device.

The invention relates to a method of using a handheldable pulling and compressing device for the repair of motor vehicle components, and to a system for carrying out the method.

Handheldable pulling devices, i.e. devices that can be used mobile by one person, such as handheld riveting tools for setting blind rivet elements, such as blind rivets and blind rivet nuts, which have a drive unit with an electric motor-driven screw drive, are known from the prior art in a variety of designs. In addition, there are also electric compressing devices which also use a screw drive to convert the rotational movement generated by an electric motor into a linear movement of the pressing tool, for example to carry out punching processes or to set punch rivets.

The riveting and compressing devices described above are used, for example, in workshop operations, in particular in motor vehicle workshops, in the context of repair work on the bodywork of vehicles, defective systems, equipment, devices or the like. The difficulty in the repair of defective motor vehicle components, in particular defective body components, for example rivets or defective motor vehicle electronic components, e.g. crimped cables, is that due to the large number of different vehicles and vehicle variants, a large number of different motor vehicle components are used. This diversity poses a major challenge in selecting a tool for the handheldable pulling and compressing device suitable for repairing the motor vehicle component, since motor vehicle components, especially of one type, often differ only slightly from one another, namely in only a few features.

Even for the specialist, the selection of the suitable tool thus represents a great challenge, which is burdened with a high susceptibility to error. An incorrect selection of the component to be replaced then leads to longer downtimes and higher costs.

From this, the invention is based on the object of providing a method for using a handheldable pulling and compressing device for the repair of motor vehicle components, as well as a system for carrying out the method, which enables a suitable tool to be selected quickly and reliably in a simple manner.

The invention solves the object by a method with the features of claim 1 and a system with the features of claim 9. Advantageous further embodiments are given in the dependent claims.

The handheldable pulling and compressing device has a drive unit comprising a battery-operated electric motor and a screw drive connected to the electric motor for transmitting pulling (tensile) forces and compressive forces resulting from the direction of rotation of the electric motor to a coupling unit. Furthermore, the pulling and compressing device comprises a tool holder connected to the coupling unit.

In the method of using the handheldable pulling and compressing device for repairing motor vehicle components according to the invention, the following method steps are carried out:
identifying a motor vehicle component to be machined by means of a mobile handheld device with a display unit and a transmitting and receiving unit for wireless data transmission of information to a server unit;
selecting a tool suitable for machining the identified motor vehicle component by means of the mobile handheld device and/or the server unit;
displaying information about the suitable tool on the display unit of the mobile handheld device;
arranging the appropriate tool on the tool holder of the handheldable pulling and compressing device;
machining the motor vehicle component by means of the handheldable pulling and compressing device.

The method according to the invention is characterized by the fact that it enables simple and reliable selection of the appropriate tool using a mobile handheld device. For this purpose, the mobile handheld device has a display unit for displaying information and a transmitting and receiving unit for wireless data transmission of information to a server unit.

In particular, when using the method in the field of repair facilities, especially motor vehicle repair facilities, this method can be used to facilitate the selection of the suitable tool for the handheldable pulling and compressing device in a simple, convenient as well as reliable way for the workshop employee. By selecting a suitable tool for the identified motor vehicle component using the mobile handheld device and/or the server unit, the time required to set up the handheldable pulling and compressing device is reduced, as is the risk of selecting incorrect tools. This can reduce the repair time and thus the costs for machining and/or repairing the motor vehicle component.

The defective motor vehicle component, for example a cable, a tube, a rivet or a crimp connection, is identified by the workshop employee using the mobile handheld device. Based on the identified motor vehicle component, the tool suitable for machining the identified motor vehicle component is selected by means of the mobile handheld device and/or the server unit communicating with the mobile handheld device via the transmitting and receiving unit. The information on the suitable tool is displayed on the display unit of the handheld mobile device, for example in the form of written, visual and/or audiovisual instructions, for example as images or videos. The workshop employee arranges the tool matching the information displayed on the mobile handheld device on the tool holder of the handheld pulling and compressing device. The machining operation then begins, in which the workshop employee machines, in particular repairs, the motor vehicle component using the handheldable pulling and compressing device.

For this purpose, the workshop employee is able to take the corresponding tool from a tool box and/or storage that may be present or to reserve it. Particularly advantageously, reservation options are also displayed in addition to the information given on the display unit, whereby the workshop employee has the particularly advantageous option of reserving the desired tool directly on the display unit, e.g. in an EDP system. This makes it particularly convenient for the workshop employee to select a suitable tool for machining and/or repairing a defective motor vehicle component, to arrange the suitable tool on the handheldable pulling and compressing device or, if necessary, to reserve it for use, for example by activating a corresponding signal device at its storage location, so that the machining and/or repair of the defective motor vehicle component can then be planned or can take place within a very short time.

In principle, the motor vehicle component to be machined can be identified in any way, whereby the workshop employee uses the mobile handheld device, for example, to display images of motor vehicle components to be identified stored in a database on the server unit on the display unit of the mobile handheld device and to compare them with the motor vehicle component. According to an advantageous further development of the invention, however, it is provided that an electronic image of the motor vehicle component to be identified is created using a camera unit of the mobile handheld device in order to identify the motor vehicle component. The electronic image is transmitted to an evaluation unit of the server unit via the transmitting and receiving unit for identification of the motor vehicle component in the server unit by comparison with images of motor vehicle components to be identified stored in a database. The information on the identified motor vehicle component stored in the database for selecting the suitable tool is transmitted to the handheld device.

To create the electronic image, the workshop employee points the handheld device with the camera unit at the motor vehicle component to be identified. Once the electronic image has been created by the workshop employee using the camera unit of the mobile handheld device, it is transmitted to the server unit via the transmitting and receiving unit. Within the server unit, the evaluation unit then compares the electronic image with the images stored in the database of the server unit, whereby the data for a matching motor vehicle component stored in the database, e.g. a product designation of the identified motor vehicle component, is then in turn transmitted by the server unit to the mobile handheld device for selection of the suitable tool. The wireless data transmission takes place, for example, via Bluetooth, a mobile network or via a WLAN connection within the repair facility. The information on the identified motor vehicle component is preferably displayed on the display unit of the mobile handheld device, usually an electronic display.

The use of the mobile handheld device enables simple and reliable identification of motor vehicle components. By linking the database to a central server unit, the user can always be provided with up-to-date information by means of a central update of the linked data. Thus, unlike in the case of identification running only locally on the mobile handheld device, it is not necessary to regularly update the information then stored on the handheld device.

In principle, a suitable tool can be selected in any way by means of the mobile handheld device and/or the server unit, a suitable tool being selected, for example, by manually entering the product designation of the identified motor vehicle component displayed on the display unit and comparing it with information stored for this motor vehicle component on the mobile handheld device or the server unit. According to an advantageous further development of the invention, however, it is provided that the information on the tool suitable for machining the motor vehicle component is stored in the database, the suitable tool is selected by means of the evaluation unit on the basis of the identified motor vehicle component, and the information is transmitted to the mobile handheld device for display on the display unit. The information on a suitable type of tool, e.g. a press tool, is preferably linked to the electronic images of the motor vehicle components stored in the database, so that after the motor vehicle component has been identified by means of the evaluation unit, only the suitable size of the tool and/or a suitable insert for the tool is selected. The fact that the information for a suitable tool is also stored in the database of the server unit and is preferably linked to the stored electronic images of the motor vehicle components enables a particularly fast and reliable selection of the suitable tool. After selection by the evaluation unit, the information on the suitable tool is recorded via the transmitting and receiving unit of the mobile handheld device and displayed on the display unit for the workshop employee, so that all that is required to select a tool suitable for machining the motor vehicle component is for the workshop employee to create an electronic image of the motor vehicle component using the mobile handheld device.

The machining operation, e.g. a pulling and compressing operation, can be controlled, for example, by means of a control unit arranged on the handheldable pulling and compressing device and connected to the drive unit. For this purpose, the control unit is preferably designed for controlling the pulling and compressing operations and/or archiving the pulling and compressing operations. For example, the control unit can be used to set the respective tensile and compressive forces in a particularly simple manner, so that the pulling and compressing operations can be carried out particularly reliably. The control unit can also be provided for archiving the pulling and compressing operations performed so that the work performed can be reliably logged.

The control unit is particularly preferably connected to a sensor unit for monitoring the pulling and compressing operations. The sensor unit can be designed to monitor the adjustment travel, the pulling and compressive forces, the torque or similar, which is required for the execution of the operations and their successful completion.

According to an advantageous further development of the invention, it is further provided that the handheld pulling and compressing device for machining the motor vehicle component is controlled by means of the control unit, the control unit retrieving a program stored in the database of the server unit or on the mobile handheld device for the suitable tool via the mobile handheld device by means of a communication unit of the handheld pulling and compressing device. The control unit is provided with a display, for example, which enables the workshop employee to operate the handheldable pulling and compressing device independently of the mobile handheld device. The control unit is connected to the mobile handheld device via the communication unit, for example via a cable or preferably wirelessly, e.g. via Bluetooth or via a WLAN connection within the repair facility, and/or to the central database of the server unit via suitable wireless transmission means described above.

Preferably, the program is stored in the server unit and linked to the electronic images and/or the information on the suitable tool. The program stored in the server unit is particularly preferably transferred with the information on the identified motor vehicle component and/or the information on the suitable tool to the mobile handheld device and/or the communication unit of the handheldable pulling and compressing device. For controlling the operation, the program is executed on the handheld mobile device, for example, so that the operation is controlled via a permanent connection of the handheld mobile device to the communication unit and the control unit. Preferably, the communication unit has a sufficient memory for at least one, preferably several programs, so that a program stored for a suitable tool is transmitted directly from the server unit or indirectly via the mobile handheld device to the memory of the communication unit before the start of the machining operation and is stored therein at least for the running of the program. In this way, errors due to connection interruptions can be counteracted. Particularly preferably, the program transmitted from the server unit to the mobile handheld device can be adapted by the workshop employee before transmission to the communication unit, so that, for example, a torque for the electric motor that deviates from the program can be set or alternative tensile or compressive actual forces can be defined.

With the programs stored in the database for various tools, the appropriate control program for the suitable tool can be automatically transferred to the mobile handheld device and/or the communication unit of the handheld pulling and compressing device. The manual setting option of the transferred program on the mobile handheld device nevertheless enables the workshop employee to make individual changes in the individual repair case.

The design of the identification of the motor vehicle component carried out in the evaluation unit can basically be carried out in any way, whereby various methods can be used for object recognition. According to an advantageous further development of the invention, it is provided that for identification of the motor vehicle component in the mobile handheld device or in the evaluation unit, the shape type of the motor vehicle component and/or at least one object marking of a label arranged on the motor vehicle component to be identified is determined by automatic shape detection of the electronic image.

In the case of the intended use of the method for repairing a crimp connection in the automotive sector, for example, the shape type represents the external shape of the cable and/or the crimp connection. When determining the geometric shape of the cable or a crimp contact, for example, its diameter, width, length and/or height as well as the shape of a sleeve of the crimp contact can be determined. The object features determined can then be matched with the object features of the electrical images of the motor vehicle components stored in the database. In addition or alternatively to pattern recognition via the shape type of the motor vehicle component, the further developed method provides that an object marking of the motor vehicle component to be identified is detected during or before the creation of the electronic image. An object marking can be certain features of the motor vehicle component to be identified that are independent of the shape, for example special markings, embossings and the color design, but also labels or the like applied to the surface. Furthermore, the object marking is preferably formed by a coding arranged on the motor vehicle component. In addition to a two-dimensional code, such as a barcode or QR code, this can also be a three-dimensional code that has protruding elevations, for example in the form of dots or bars, and which are provided particularly advantageously with reflective coatings, so that particularly reliable recognition of this object marking can take place as part of the creation of the electronic image.

Particularly in the case of combined detection of the shape type and the object marking, the motor vehicle component to be identified can be identified particularly reliably and quickly in the evaluation unit by comparison with the motor vehicle components stored in the database, since false detection can be reduced via an increasing number of matching features.

For the selection of a suitable tool, in addition to the selection of the appropriate tool type, the selection of the appropriate tool size is also decisive. For example, the tool size for a tool type can be determined by a manual measurement of a characteristic dimension of the motor vehicle component, e.g. for the case of a cable its diameter, and the input into the mobile handheld device by the workshop employee. According to an advantageous further development of the invention, however, it is provided that, during the creation of the electronic image, the size of the motor vehicle component to be identified is determined by means of a sensor unit of the mobile handheld device. The sensor unit is designed, for example, as a distance sensor or as a motion sensor. Furthermore, the sensor unit can be designed as a LIDAR. The size of the motor vehicle component to be identified can also be determined during automatic shape detection using a plurality of cooperating sensor units of the mobile handheld device. When the electronic image is created, the size of the motor vehicle component to be identified is determined by means of the sensor unit and transmitted to the server unit for identification of the motor vehicle component with the electronic image. For the selection of the suitable tool, the determined size of the motor vehicle component is preferably taken into account in the evaluation unit, so that information about a suitable tool of suitable tool type and suitable tool size is transmitted to the mobile handheld device for display on the display unit. By detecting the size of the motor vehicle component by means of the sensor unit of the mobile handheld device, the risk of incorrect tool selection can be further reduced.

According to an advantageous further development of the invention, it is provided that the mobile handheld device is connected to the vehicle before the motor vehicle component is going to be repaired, vehicle data is read out by means of the mobile handheld device and, based on the vehicle data, a machining history of the motor vehicle component identified and to be machined is displayed on the display unit. The mobile handheld device is preferably connected to the vehicle via on-board diagnostic access (OBD) by means of a cable connection or wirelessly, e.g. by means of Bluetooth. Vehicle data means usual information to be read out for the repair of a vehicle, e.g. the vehicle type, error messages or the repair history of the vehicle. The machining history of previously repaired motor vehicle components, for example the motor vehicle component identified by means of the mobile handheld device, is stored in the vehicle repair history.

According to an advantageous further development of the invention, it is provided that two switching elements arranged on the pulling and compressing device are actuated simultaneously to initialize the machining operation of the motor vehicle component by means of the handheldable pulling and compressing device. Here, simultaneous is understood to mean that both switching elements are actuated, for example, by the workshop employee at the same time. For this purpose, the switching elements are preferably connected to the control unit. A first switching element is arranged, for example, on a housing body of the handheldable pulling and compressing device. A second switching element is also arranged, for example, on the housing body or, for example, in the case of a riveting tool, preferably on the rivet clamp.

Actuation of only one of the switching elements is not sufficient to initialize the machining operation. Particularly preferably, a visual error message is shown on the display of the handheldable pulling and compressing device if only one of the switching elements is actuated. Alternatively or additionally, an error message is transmitted to the handheld mobile device via the communication unit connected to the control unit and is reproduced visually on the display unit and/or audio visually in connection with a loudspeaker of the handheld mobile device. By simultaneously actuating the two switching elements, the machining operation for repairing the identified motor vehicle component is initialized and, preferably, the program called up by the server unit and/or the mobile handheld device is executed for the suitable tool selected and arranged on the tool holder. As the initialization of the machining operation requires the actuation of two switching elements, an undesired initialization of the machining operation, for example due to the carelessness of the workshop employee, can be counteracted in an advantageous manner. This ensures that the machining operation does not start until the motor vehicle component has been identified and the appropriate tool has been selected and arranged.

In addition to the handheld pulling and compressing device, the system for carrying out the method according to the invention has the mobile handheld device with a camera unit, a display unit and a transmitting and receiving unit for wireless data transmission of information to a server unit.

The screw drive has a threaded spindle connected to the electric motor and rotatably mounted on a housing body, and a threaded nut rotatably mounted on the threaded spindle and non-rotatably mounted on the housing body via a bearing unit. The coupling unit is connected to the threaded nut in such a way that both tensile and compressive forces resulting from the direction of movement of the threaded spindle and the resulting linear adjustment of the threaded nut are reliably transmitted from the threaded nut via the coupling unit to the tool holder.

In addition, the system is particularly advantageously connected to a server unit that comprises
a database with stored images of the motor vehicle components to be identified, information on tools and programs for controlling the handheldable pulling and compressing device, and
an evaluation unit for identifying the motor vehicle component in the server unit by comparing the image to be transmitted with the images stored in the database and for selecting a suitable tool.

The system has at least two different tools, e.g. a pulling tool and a compressing tool. The compressing tool is designed, for example, as a riveter, which is used in conjunction with a rivet clamp arranged on the pressing device for setting rivets. In addition, the compressing tool is designed, for example, for pressing pipes and/or pipe connections. Furthermore, the compressing tool is designed, for example, as a crimping punch, which is used in conjunction with a crimping die arranged on the compressive device for making a crimp connection. When used as a pulling device, a suitable clamping device for a blind rivet shank or other means of transmitting tensile forces is arranged on the tool holder, for example. Alternatively or additionally, corresponding pulling tools are arranged on the tool holder, for example, the pulling tools having clamping means by means of which the tensile forces can then be transmitted.

The system designed in this way enables the user to select a suitable tool for machining and/or repairing a motor vehicle component using the mobile handheld device alone, e.g. in the workshop. This can be done, for example, directly on the vehicle in the vehicle workshop, without the need for dismantling. The mobile handheld device is characterized by its high flexibility and usability. The data of the motor vehicle component to be identified is sent as an electronic image directly from the handheld device to the server unit, which can be arranged locally in the workshop or in a central office, for example, via which the handheld device communicates using a mobile phone connection or WLAN connection.

The handheld device of the system is preferably designed for manual input of information. This enables the user, for example, to individually adapt the program transferred to the mobile handheld device for the suitable tool.

Particularly preferably, the mobile handheld device is formed by a tablet or a smartphone. The use of a smartphone is characterized by the fact that these usually already have a display unit, a camera unit and a motion sensor or a distance sensor, so that the creation of the electronic image with the size recognition of the motor vehicle component can then take place using a program application (app) running on the mobile device. During the creation of the electronic image, for example, frame lines or application notes can be displayed on the display unit of the mobile device by means of the app.

The app can also establish a link to an IT system via which a reservation of the selected tool for future machining and/or repair work can then be carried out directly in a simple manner via the smartphone. Preferably, the handheldable pulling and compressing device can be controlled with the app in conjunction with the smartphone by the workshop employee using voice and/or gesture control. The data exchange between the handheldable pulling and compressing device and the handheld mobile device preferably takes place between the communication unit of the handheldable pulling and compressing device and the transmitting and receiving unit of the handheld mobile device.

Preferably, the system has a plurality of pulling and compressing tools with interchangeable inserts. The inserts have, for example, different component receptacles, in particular for motor vehicle components. A component receptacle is a free area of the insert for arranging the motor vehicle component to be machined with the pulling and compressing device. For example, the component receptacles differ in type and size due to different geometries, e.g. a cylindrical geometry for receiving a cable, a tube or a strut. For example, different inserts for common cable diameters can be arranged on a compressing tool designed as a crimping die. In addition, the crimping punch can preferably be combined with different crimping punches to produce different crimp connections, for example a C-crimp or an F-crimp.

The plurality of different pulling and compressing tools enables a wide range of applications for the handheldable pulling and compressing device. The inserts ensure the use of a suitable tool due to the broad coverage of different geometries of various or type-same motor vehicle components for machining, in particular repair of various motor vehicle components.

An embodiment of the invention is explained below with reference to the drawings. In the drawings show:

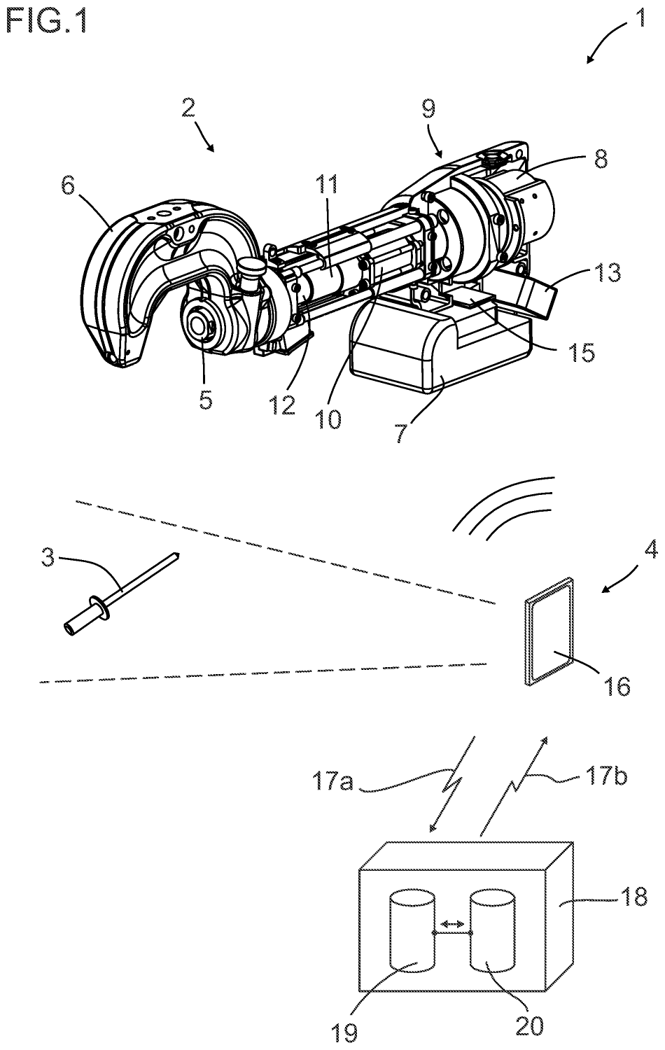

FIG. 1 a schematic representation of a system for carrying out a method of using a handheldable pulling and compressing device for the repair of motor vehicle components.

A system 1 for carrying out a method of using a handheldable pulling and compressing device 2 for repairing motor vehicle components 3 is shown schematically in FIG. 1. In addition to the handheldable pulling and compressing device 2, the system 1 has a mobile handheld device designed as a smartphone 4 and a plurality of pulling and compressing tools. FIG. 1 shows an example of a pressing tool in the form of a riveting punch 5 in conjunction with a rivet clamp 6.

The handheldable pulling and compressing device 2 has a drive unit 9 comprising an electric motor 8 operated by a rechargeable battery 7 and a screw drive 10 connected to the electric motor 8 for transmitting tensile and compressive forces resulting from the direction of rotation of the electric motor 8 to a coupling unit 11. Furthermore, the pulling and compressing device 2 has a tool holder 12 connected to the coupling unit 11. The tensile and compressive forces can be transmitted to the tool holder 12 via the coupling unit 11.

A control unit 13 and a sensor unit connected to the control unit 13 in the form of a rotary encoder for detecting the torque of the electric motor 8 are further arranged on the handheldable pulling and compressing device 2. The control unit 13 is connected to a communication unit 15 for exchanging data with the smartphone 4.

The smartphone 4 has a display unit in the form of an electronic display 16 for displaying information and a transmitting and receiving unit for wireless data transmission 17a, 17b of information to a server unit 18. Furthermore, the smartphone 4 has a camera unit for creating an electronic image of a motor vehicle component 3 to be identified, and a distance sensor for detecting the size of the motor vehicle component 3 when creating the electronic image.

The server unit 18 has a database 19 with stored images of motor vehicle components 3, information on tools 5 and programs for controlling the handheldable pulling and compressing device 2. Further, the server unit 18 has an evaluation unit 20 for identifying the motor vehicle component 3 in the server unit 18.

To use the handheldable pulling and compressing device 2 to repair a motor vehicle component in the form of a rivet 3 shown here as an example, first the rivet 3 is identified by means of the smartphone 4. For this purpose, a user creates an electronic image of the rivet 3 using the camera unit of the smartphone 4. The distance sensor of the smartphone 4 determines the size of the rivet 3 when the electronic image is created.

The electronic image created in the smartphone 4 is transmitted to the server unit 18 via a wireless connection, for example a mobile phone connection with the determined size of the rivet 3, whereby the data transmission 17a, 17b can take place from the smartphone 4 to the server unit 18 and vice versa. Within the server unit 18, the electronic image is analyzed within the evaluation unit 20 and, for example, compared with the electronic images of rivets 3 stored in the database 19 within the scope of a shape detection, in this case of the edge shape of the rivet 3.

Information on tool types in the form of riveters suitable for machining different rivets is linked to the electronic images of the rivets stored in the database 19, so that after the rivet 3 has been identified by means of the evaluation unit 20, the appropriate size of the riveter is determined on the basis of the determined size of the rivet 3. In addition, for the suitable riveter 5 a program for controlling the handheldable pulling and compressing device 2 is stored in the database. For this purpose, the program is retrieved from the server unit 18 via the transmitting and receiving unit of the smartphone 4 together with the information on the identified rivet 3 and the riveter 5 suitable for machining the rivet 3. The program is forwarded to the communication unit 15 connected to the control unit 13, and the information on the identified rivet 3 and the riveter 5 suitable for machining the rivet 3 is displayed on the electronic display 16 of the smartphone 4.

The user, e.g. a workshop employee, arranges the riveter 5 matching the information displayed on the smartphone 4 on the tool holder 12 of the handheldable pulling and compressing device 2. The machining operation then begins, in which the workshop worker fastens the rivet 3 to a body part by means of the handheldable pulling and compressing device 2. The control unit 13 controls the machining operation by executing the program retrieved from the server unit 18 in response to the signals from the rotary encoder.

All features explained in connection with individual embodiments of the invention may be provided in different combinations for the method of using the handheldable pulling and compressing device 2 for repairing motor vehicle components 3 and/or the system 1 for carrying out the method in order to realize their beneficial effects, even though they have been described for different embodiments.

The scope of protection of the present invention is given by the claims and is not limited by the features explained in the description or shown in the FIGURES.

### LIST OF REFERENCE SIGN

1 System
2 Handheldable pulling and compressing device
3 Motor vehicle component/rivet
4 Smartphone
5 Tool/riveting punch
6 Rivet clamp
7 Rechargeable battery
8 Electric motor
9 Drive unit
10 Screw drive
11 Coupling unit
12 Tool holder
13 Control unit
15 Communication unit
16 Display unit/electronic display
17a, 17b Wireless data transmission
18 Server unit
19 Database
20 Evaluation unit

1. Method of using a handheldable pulling and compressing device for the repair of motor vehicle components, having
a drive unit (9) comprising a battery-operated electric motor (8),
a screw drive (10) connected to the electric motor (8) for transmitting tensile and compressive forces resulting from the direction of rotation of the electric motor (8) to a coupling unit (11), and
a tool holder (12) connected to the coupling unit (11),
with the steps
identifying a motor vehicle component (3) to be machined by means of a mobile handheld device (4) comprising a display unit (16) and a transmitting and receiving unit for wireless data transmission of information to a server unit (18);
selecting a tool (5) suitable for machining the identified motor vehicle component (3) by means of the mobile handheld device (4) and/or the server unit (18);
displaying information about the appropriate tool (5) on the display unit (16) of the mobile handheld device (4);
arranging the appropriate tool (5) on the tool holder (12) of the handheldable pulling and compressing device (2);
machining the motor vehicle component (3) by means of the handheldable pulling and compressing device (2).

2. Method according to claim 1, characterized in that, for identification of the motor vehicle component
an electronic image of the motor vehicle component (3) to be identified is created with a camera unit of the mobile handheld device (4),
the electronic image is transmitted to an evaluation unit (20) of the server unit (18) via the transmitting and receiving unit for identifying the motor vehicle component (3) in the server unit (18) by comparison with images of motor vehicle components to be identified stored in a database (19), and
the information stored in the database (19) for the identified motor vehicle component (3) is transmitted to the handheld device (4) for selection of the suitable tool (5).

3. Method according to claim 1, characterized in that the information on the tool (5) suitable for machining the motor vehicle component (3) is stored in the database (19), the suitable tool (5) is selected by means of the evaluation unit (20) on the basis of the identified motor vehicle component (3), and the information is transmitted to the mobile handheld device (4) for display on the display unit (16).

4. Method according to claim 1, characterized in that the handheldable pulling and compressing device (2) for machining the motor vehicle component (3) is controlled by means of a control unit (13), the control unit (13) calling up a program stored in the database (19) of the server unit (18) or on the mobile handheld device (4) for the suitable tool (5) via a communication unit (15) of the handheldable pulling and compressing device (2) via the mobile handheld device (4).

5. Method according to claim 1, characterized in that, in order to identify the motor vehicle component (3) in the mobile handheld device (4) or in the evaluation unit (20), the shape type of the motor vehicle component (3) and/or at least one object marking of a label arranged on the motor vehicle component (3) to be identified is determined by automatic shape detection of the electronic image.

6. Method according to claim 1, characterized in that during the creation of the electronic image, the size of the motor vehicle component (3) to be identified is determined by means of a sensor unit of the mobile handheld device (4).

7. Method according to claim 1, characterized in that the mobile handheld device (4) is connected to the vehicle before the repair of the motor vehicle component (3), vehicle data is read out by means of the mobile handheld device (4), and a machining history of the motor vehicle component (3) identified and to be machined is displayed on the display unit (16) based on the vehicle data.

8. Method according to claim 1, characterized in that two switching elements arranged on the pulling and compressing device (2) are actuated simultaneously by means of the handheldable pulling and compressing device (2) in order to initialize the machining operation of the motor vehicle component (3).

9. System for carrying out a method of using a handheldable pulling and compressing device for the repair of motor vehicle components, in particular according to claim 1, comprising
a handheldable pulling and compressing device (2) comprising a drive unit (9) having a battery-operated electric motor (8), a screw drive (10) connected to the electric motor (8) for transmitting tensile and compressive forces resulting from the direction of rotation of the electric motor (8) to a coupling unit (11), and a tool holder connected to the coupling unit (11),
a mobile handheld device (4) with a camera unit, a display unit (16) and a transmitting and receiving unit for wireless data transmission of information to a server unit (18), and
at least two different tools (5).

10. System according to claim 9, characterized by a plurality of pulling and compressing tools (5) with exchangeable inserts.
